(19) United States
(12) Patent Application Publication
(10) Pub. No.: US 2009/0295173 A1
(43) Pub. Date: Dec. 3, 2009

(54) Extension Bolt Assembly

(75) Inventor: George E. Heid, Charlotte, NC (US)

Correspondence Address: BANNER & WITCOFF, LTD., TEN SOUTH WACKER DRIVE, SUITE 3000, CHICAGO, IL, 60606, US

(73) Assignee: Newell Operating Company, Atlanta, GA (US)

(21) Appl. No.: 12/476,030

(22) Filed: Jun. 1, 2009

Related U.S. Application Data
(60) Provisional application No. 61/057,284, filed on May 30, 2008.

(51) Int. Cl. E05C 1/08; E05B 15/02

(52) U.S. Cl. 292/139; 292/340

(57) ABSTRACT

A multi-point locking assembly is configured for use with a door mounted within a frame, and includes a lock mechanism mounted in the door. The lock mechanism has a moveable actuator. An extension bolt assembly is removably connected to the actuator, and includes an extension bolt that is moveable by movement of the actuator between an extended position and a retracted position. A guide assembly is adapted to be mounted in the door adjacent the frame. The guide assembly has a passage therethrough. The extension bolt extends through the passage in the guide assembly and the extension bolt is rotatable within the passage.

### CROSS-REFERENCE TO RELATED APPLICATIONS

This application claims priority to and the benefit of U.S. Provisional Application No. 61/057,284, filed May 30, 2008, which is incorporated by reference herein in its entirety and made part hereof.

### TECHNICAL FIELD

The invention relates to lock assemblies for use in a door or similar structure, and more specifically, to assemblies including extension bolts for use in locking such lock assemblies.

### BACKGROUND

A number of lock assemblies exist for locking doors, windows, panels, and other such swinging, sliding, or otherwise moveable members, including both single-point and multi-point lock assemblies. Some existing multi-point lock assemblies utilize extension bolts or shoot bolts that extend from the top, bottom, and/or other edges of the movable member to lock the member to a frame or similar structure. However, these and other existing lock assemblies present certain drawbacks and disadvantages. For example, in some existing lock assemblies, removing or adjusting the extension bolts may require time-consuming removal of other components, such as guides for the extension bolts that prevent rotation of the bolts. The present assembly is provided to solve the problems discussed above and other problems, and to provide advantages and aspects not provided by prior lock assemblies of this type. A full discussion of the features and advantages of the present invention is deferred to the following detailed description, which proceeds with reference to the accompanying drawings.

### BRIEF SUMMARY

Aspects of the invention relate to a multi-point locking assembly configured for use with a door mounted within a frame, and includes a lock mechanism, which contains a moveable actuator, mounted in the door. An extension bolt assembly is removably connected to the actuator, and includes an extension bolt that is moveable by movement of the actuator between an extended position and a retracted position. A guide assembly is adapted to be mounted in the door adjacent the frame. The guide assembly has a passage therethrough. The extension bolt extends through the passage in the guide assembly and the extension bolt is rotatable within the passage.

According to one aspect, the guide assembly includes a base adapted to be mounted in the door and a guide received within the base. The guide has the passage therethrough for receiving the extension bolt.

According to another aspect, the bolt is rotationally fixed with respect to the guide, and the guide is rotatable within a base passage in the base to effect rotation of the bolt with respect to the guide assembly.

According to a further aspect, the base passage includes a plurality of lugs with recesses located between the lugs, and an outer surface of the guide has a plurality of protrusions with flutes located between the protrusions. The guide and the base passage may be cooperatively dimensioned so that when torque is applied to the bolt, the lugs of the base passage contact the protrusions of the guide to resist rotation of the guide within the base passage. Application of sufficient torque causes the lugs to slip past the protrusions to permit rotation of the guide and the bolt within the passage. The guide may create an audible and/or tactile indication, such as an audible click and/or a tactile snap, when the lugs slip past the protrusions. Additionally, when no torque is applied to the bolt, the guide and the base passage may fit together such that the lugs of the base passage are received in the flutes of the guide, with the protrusions of the guide are received in the recesses of the base passage.

According to yet another aspect, the extension bolt assembly includes a threaded connection, and wherein rotation of the extension bolt results in a change in vertical height of the extension bolt through action of the threaded connection. In one embodiment, the extension bolt assembly further includes a connecting rod connected at one end to the actuator by the threaded connection and connected at the opposite end to the extension bolt. The connection between the extension bolt and the rod is sufficiently tight that rotation of the extension bolt results in rotation of the rod and a change in vertical height of the rod through action of the threaded connection.

According to still another embodiment, the guide assembly further comprises a base and a guide formed of a single piece, with the guide having the passage therethrough for receiving the bolt. The bolt is rotatable within the passage in the guide. In this aspect, the outer surface of the bolt may be cooperatively dimensioned with the inner surface of the passage to resist rotation until a sufficient torque is provided for rotation.

Additional aspects of the invention relate to a guide assembly for use with a lock assembly, as described above.

Further aspects of the invention relate to a method of adjusting an extension bolt assembly as described above and/or a method of removing a lock assembly as described above from the door, each of which include rotating the extension bolt within the guide assembly. Adjusting the extension bolt assembly and/or removing the lock assembly can also be performed without removing the guide assembly from the door.

Other features and advantages of the invention will be apparent from the following specification taken in conjunction with the following drawings.

### BRIEF DESCRIPTION OF THE DRAWINGS

To understand the present invention, it will now be described by way of example, with reference to the accompanying drawings in which:

FIG. 1 is a schematic view of a door and multi-point lock assembly having one embodiment of an extension bolt assembly according to the invention positioned along the edge of the door;

FIG. 2 is a schematic view of a prior art door and multi-point lock assembly having a concealed extension bolt extending within a channel in the body of the door;

FIG. 3 is a schematic view of another prior art door and multi-point lock assembly having an offset extension bolt extending within a channel in the body of the door;

FIG. 4 is an exploded perspective view of one embodiment of an extension bolt and a guide assembly according to the present invention;

FIG. 5 is an exploded elevation view of the guide assembly of FIG. 4;

FIG. 5A is a top view of the guide assembly of FIG. 4, shown during insertion of the guide into the base;

FIG. 6 is a top view of the extension bolt tip and guide assembly of FIG. 4, shown as assembled;

FIG. 7 is a perspective view of a guide member of the guide assembly of FIG. 4;

FIG. 8 is a side view of the guide member of FIG. 7;

FIG. 9 is a rear perspective view of the guide member of FIG. 7;

FIG. 10 is a perspective view of a base of the guide assembly of FIG. 4;

FIG. 10A is a bottom perspective view of the base of FIG. 10;

FIG. 11 is a bottom view of the guide assembly of FIG. 4 mounted in a door;

FIG. 12 is a front perspective view of the extension bolt of FIG. 4;

FIG. 13 is a rear perspective view of the extension bolt of FIG. 12;

FIG. 14 is a bottom view of the guide assembly of FIG. 4 with the extension bolt and the guide member inserted into the base;

FIG. 15 is a bottom view of the guide assembly of FIG. 14, with the extension bolt and the guide member rotated approximately 60° from the orientation shown in FIG. 14; and

FIG. 16 is a side view of the guide assembly of FIG. 14, with broken lines showing the position of the extension bolt after rotation;

FIG. 17 is a bottom view of another embodiment of a guide assembly and an extension bolt according to the invention.

It is understood that the drawings may not be to scale.

### DETAILED DESCRIPTION

While this invention is susceptible of embodiments in many different forms, exemplary embodiments of the invention are shown in the drawings and will herein be described in detail with the understanding that the present disclosure is to be considered as an exemplification of the principles of the invention and is not intended to limit the broad aspect of the invention to the embodiments illustrated.

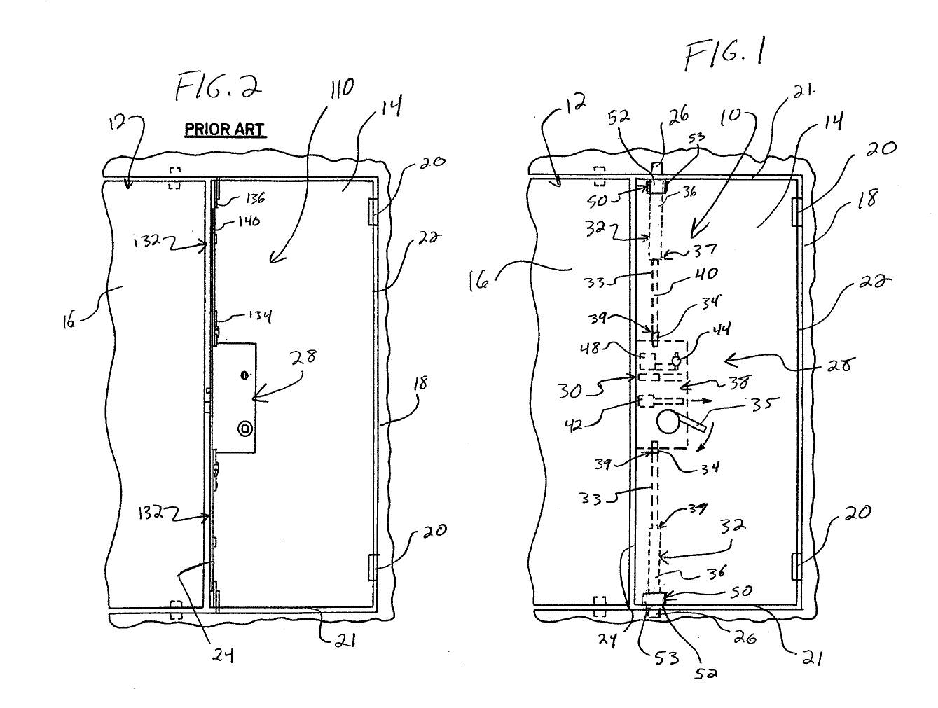

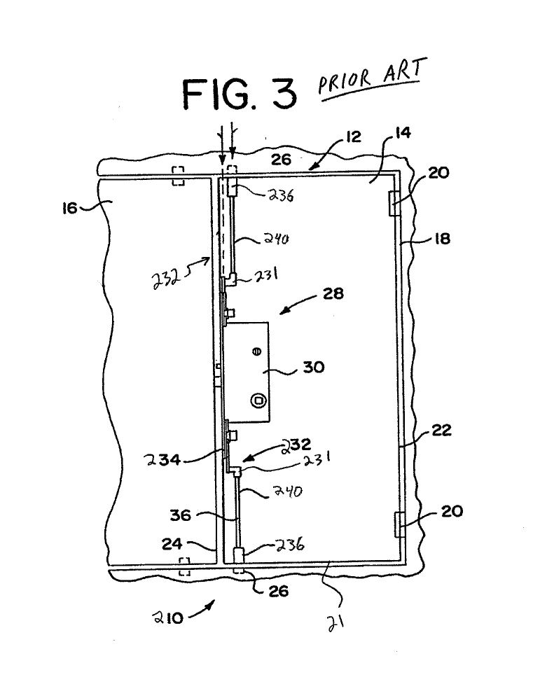

Referring now to FIG. 1, there is shown an embodiment of multi-point door locking assembly, referred to by reference numeral 10. The door lock assembly 10 is shown operatively connected to a conventional swinging door assembly 12. The door assembly 12 comprises a primary door member 14 or movable member, mounted within a master door frame 18. The primary door 14 is mounted by conventional means to provide reciprocal sliding and/or swinging movement within the door frame 18, thereby enabling ingress and egress through the door assembly 12. Such conventional mountings include hinge connections 20 along a jamb edge 22 of the door 14, or cooperative sliding track arrangement (not shown) between the frame 18 and the door member 14.

In the embodiment shown, secondary door member 16 is also mounted to the door frame 18, and is located adjacent the lock edge 24 of the door, opposite the door jamb edge 22. The secondary door 16 also may be a movable door member capable of sliding and/or swinging within the door frame 18, and having a locking assembly 10 as is depicted in the primary door member 14, or some other locking structure. Alternatively, the door member 14 is mounted without the use of a secondary door member 16, such that a portion of the door frame is located adjacent the lock edge 24 of the door 14. This embodiment of the multi-point door lock assembly 10 is operatively connected to the door assembly 12, for enabling the door member 14 to be securely locked to the door frame 18. As illustrated in FIG. 1, the lock assembly 10 is connected to the primary door member 14. It is also contemplated that the lock assembly 10 may be connected to the second door member 16, if desired, without departing from the scope of the present invention. Therefore, use of the term “door frame” may be used in reference to any adjacent structure suitable for securement of the door, including a door frame jamb 18 or an adjacent door structure 16.

The locking assembly 10 includes a lock mechanism 28 mounted within the door structure 16. Generally, the lock mechanism 28 includes a central lock body 30 with at least one extension bolt assembly 32. FIG. 1 illustrates one embodiment of an extension bolt assembly 32 in accordance with the present invention. The extension bolt assemblies 32 illustrated in FIG. 1 are each connected to an actuator member 34 of the lock mechanism 28. Additionally, the extension bolt assemblies 32 of FIG. 1 include an extension bolt member 36 (also known as a shoot bolt) and a connecting rod member 40 connecting the extension bolt member 36 to the actuator 34. In this illustrated embodiment, the rod 40 is threaded at both ends, and connects to the extension bolt 36 and to the actuator member 34 by threaded connections 37 and 39, respectively. In the embodiment shown in FIG. 1, both the actuator 34 and the extension bolt assembly 32 are spaced from the lock face 24 of the door 14, and extend within a channel 33 in the door 14. In one embodiment, the extension bolt 36 is mounted 1″ to 1¼″ from the lock face 24 of the door 14. In an alternate embodiment (not illustrated), the bolt 36 may connect directly to the actuator 34. Additionally, in another embodiment, the extension bolt assembly 32 may utilize connections other than threaded connections, including other types of connections that can be connected and released by relative rotation of the members. It is understood that while the locking mechanism 28 is referred to herein as a “multi-point” lock assembly 10, in one embodiment, the lock assembly 10 can include any number of extension bolt assemblies 32, and may include only a single extension bolt assembly 32. It is also understood that the locking assembly 10 can be utilized for locking other types of moveable members positioned within frame structures, such as windows or other structures in a swinging, sliding, or otherwise movable arrangement.

In one embodiment, the door frame 18 has one or more lock bolt receivers 26 connected to the door frame 12 for receiving each extension bolt 36 for locking the door in a selected position, as shown in the embodiment of FIG. 1. In the embodiment of FIG. 1, the frame 18 has top and bottom receivers 26, each for receiving a respective bolt 36 of the lock mechanism 28. It is understood that the multi-point lock assembly 10 may be configured to use only a single extension bolt assembly 32. It is also understood that if the secondary door 16 includes a lock assembly with one or more extension bolts, the frame 18 may have additional bolt receivers configured to interact with the lock assembly of the secondary door 16. The doors 14, 16 shown in FIG. 1 also include weather stripping 21 and/or other sealing members attached at the top and bottom thereof.

The lock mechanism 28 has an internal mechanism 38 within the central lock body 30, configured for manipulation by a user to lock and unlock the door member 14 relative the door frame 18, as known in the art. As illustrated in FIG. 1, the lock mechanism 28 may include a handle 35 or other member for manipulation of the lock mechanism 28. Manipulation of the lock mechanism 28, and resulting interface movement of the internal mechanism 38, causes movement of the actuator 34 extending from the central lock body 30. Such manipulation causes movement of the actuators 34 and the extension bolt assemblies 32 between a first position located close to the central lock body 30, and a second position that is extended a distance further from the central lock body 30. As also shown in FIG. 1, the lock mechanism 28 may also include additional locking structure, such as a locking member 42 actuatable by the handle 35, as well as a deadbolt member 48 actuatable by a turn 44 and/or the handle 35, to engage an associated portion of the second door 16 or the door frame 18, thereby providing one or more additional points of the multi-point locking arrangement. In another embodiment, the lock mechanism 28 may contain one or more extension bolt assemblies 32, and may not contain a locking member and/or a deadbolt member.

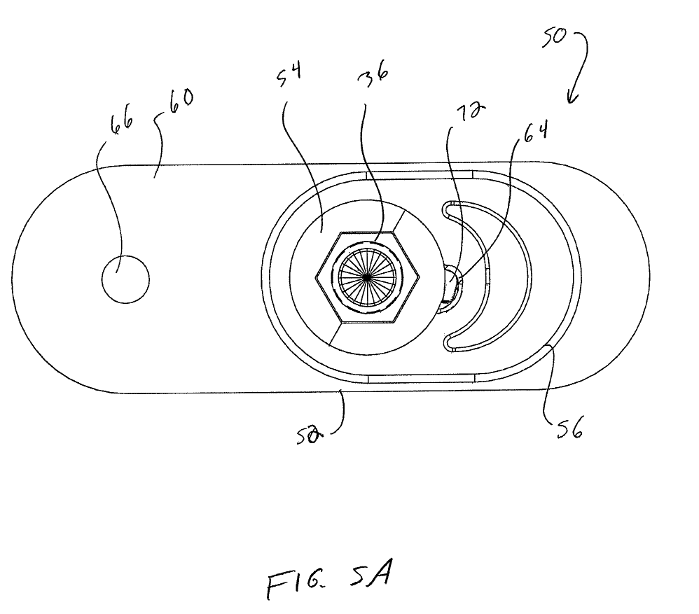

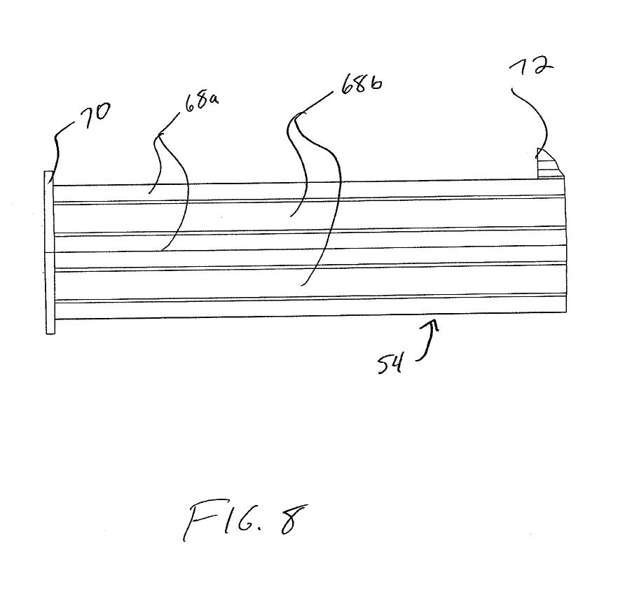

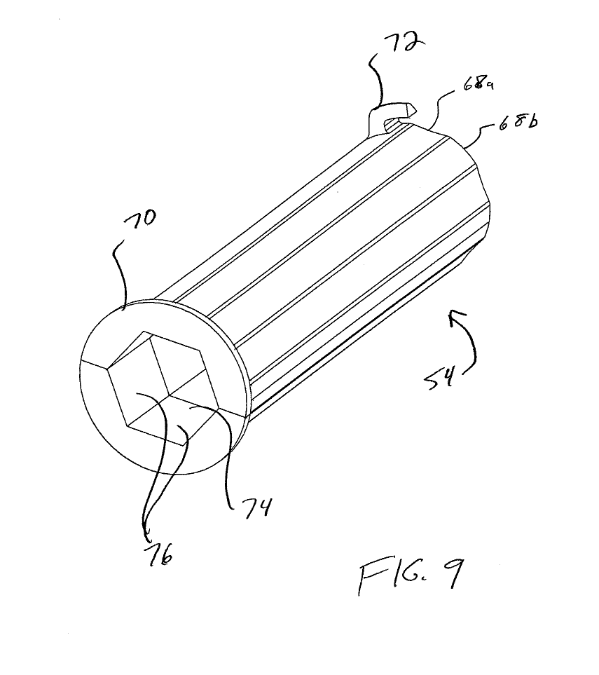

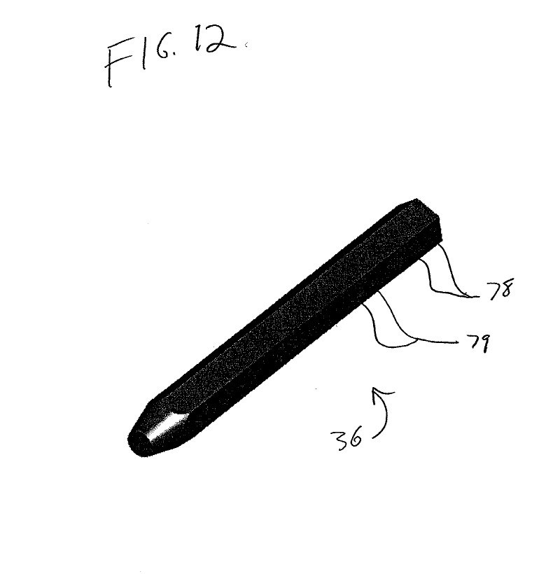

The multi-point locking assembly 10 of FIG. 1 includes guide assemblies 50 positioned at the top and bottom of the door 14, adjacent the lock bolt receivers 26. One embodiment of the guide assembly 50 is illustrated in greater detail in FIGS. 4-13. The guide assembly 50 includes a base 52 and a guide 54 adapted to be inserted within the base 52. As shown in FIG. 1, the base 52 is inserted into a cavity 53 at the top or bottom surface 23, 25 of the door 14, such that the base 52 is proximate the receiver 26. The extension bolt 36 extends through the guide assembly 50 when mounted. Generally, the guide assembly 50 functions to hold the extension bolt 36 in place and to allow rotation of the extension bolt 36 to adjust and/or remove the extension bolt 36, as described in more detail below. In one embodiment, the base 52 and the guide 54 are cooperatively dimensioned to lock together and resist rotation of the guide 54 relative to the base 52 until sufficient torque is applied, at which point the guide 54 will rotate with respect to the base 52, as also described below.

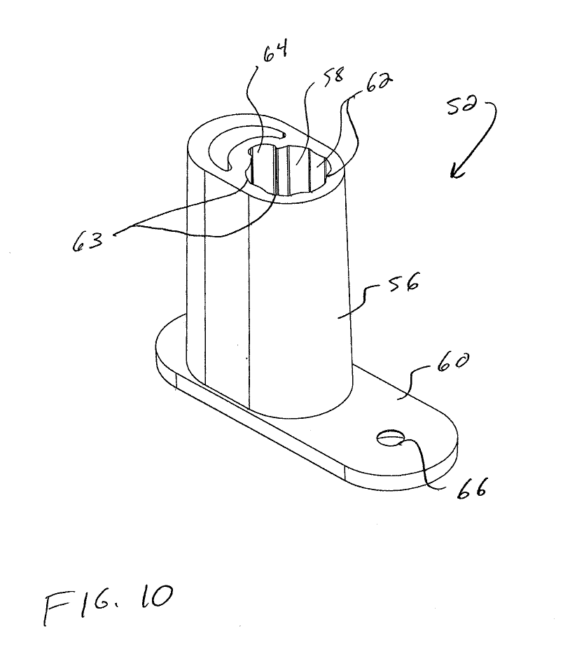

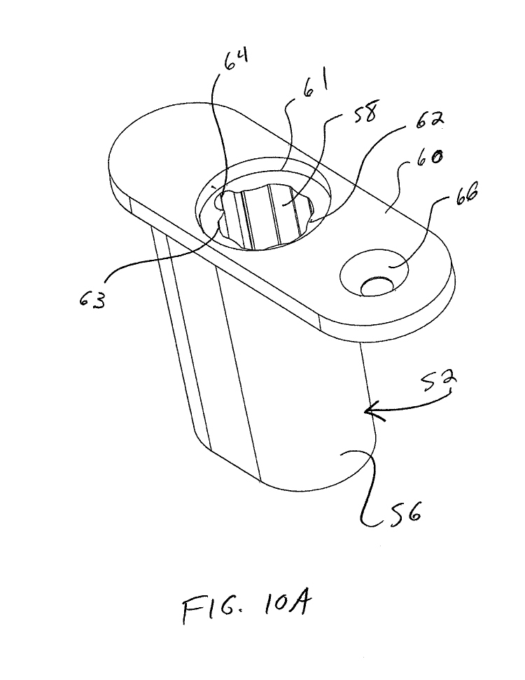

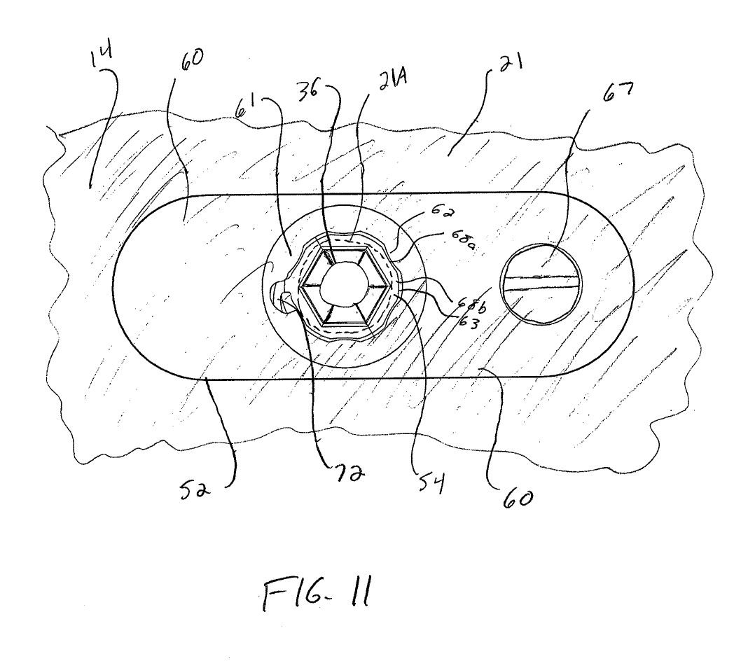

The base 52 of the guide assembly 50 illustrated in FIGS. 4-6, 10-11, and 14-16 includes a body 56 having a passage 58 therethrough and a mounting plate 60 at one end of the body 56. The interior walls of the passage 58 have a plurality of lugs 62 to engage the outer surface of the guide 54, separated by recesses 63, as described below. Additionally, in this embodiment, the passage 58 has a notch 64 running at least part of the length thereof. The mounting plate 60 includes a hole 66 adapted to receive a screw or other fastener 67 to connect the base 52 to the door 14, as shown in FIG. 11. In the embodiment of FIG. 1, when the base 52 is mounted in the door 14, the bottom surface of the mounting plate 60 can be mounted flush with the top or bottom surface 23, 25 of the door 14. At the bottom of the plate 60, the base 52 includes a countersunk region 61 surrounding the passage 58, shown in FIGS. 10A and 14-15. In one embodiment, the base 52 is manufactured from plastic, and may be manufactured by injection molding or other plastic molding techniques. In other embodiments, the base 52 may be made from another suitable material or combination of materials.

In general, the guide 54 is cooperatively dimensioned with the internal structure of the passage 58 to permit rotation of the guide 54 within the passage 58 with application of sufficient torque. In the embodiment illustrated in FIGS. 4-9 and 14-15, the guide 54 has a plurality of outer surfaces 68a-b. More specifically, in this embodiment, the guide 54 has a generally hexagonal configuration with twelve outer surfaces 68a-b, and is dimensioned so that the lugs 62 of the passage 58 engage the surfaces 68a-b when the guide 54 is inserted into the base 52, locking the guide 54 and the base 52 together. As seen in greater detail in FIGS. 9 and 11, the outer surfaces 68a-b of the guide 54 include six concave surfaces forming recesses or flutes 68a and six convex surfaces forming protrusions 68b, arranged in alternating fashion. Thus, the guide 54 is cooperatively dimensioned with the base passage 58, which has lugs 62 and recesses 63. In this configuration, the guide 54 is locked into position when the lugs 62 of the base 52 are adjacent the recesses 68a of the guide 54 and the protrusions 68b of the guide 54 are adjacent the recesses 63 of the base 52, as seen in FIGS. 11 and 14-15.

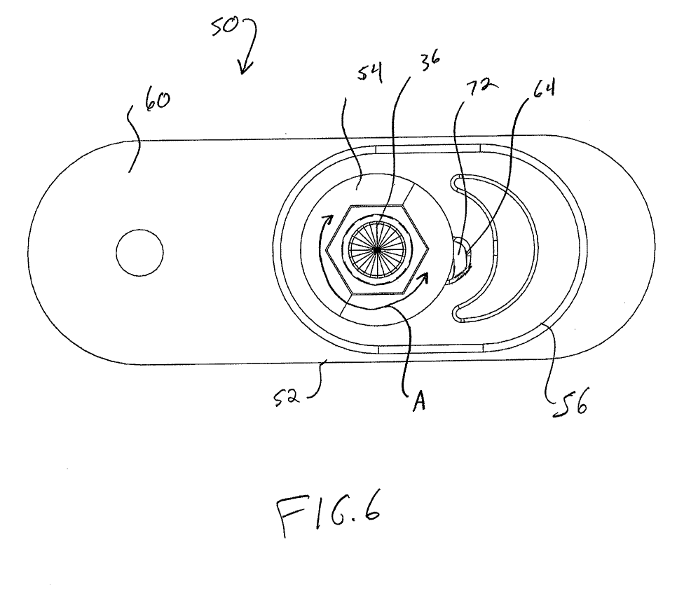

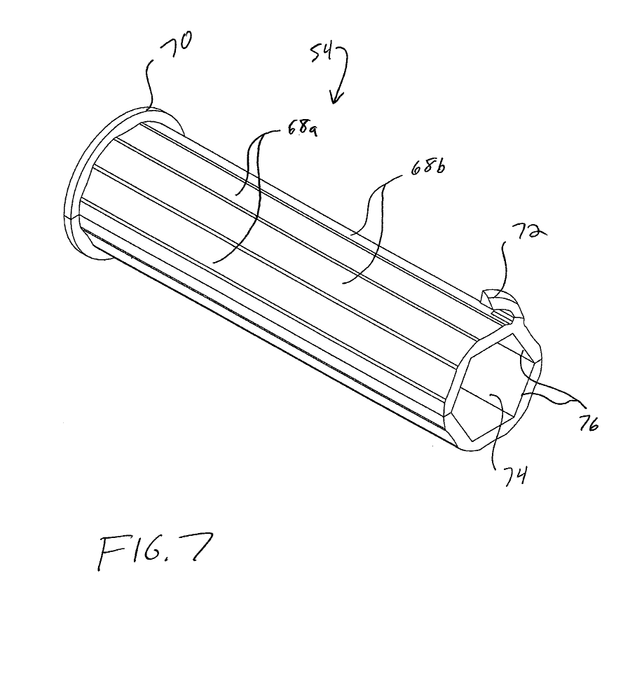

Additionally, the guide 54 has a circular flange 70 at one end and a flexible tab 72 at the opposite end. As shown in FIG. 5A, when the guide 54 is inserted into the base 52, the tab 72 is received in the notch 64 and is flexed inwardly by contacting the inner surface of the notch 64. Once the guide 54 is fully inserted, the tab 72 springs back outward and retains the guide 54 within the base 52, as shown in FIGS. 6 and 11. The countersunk region 61 of the base 52 permits the tab 72 to flex back outwardly, shown in FIG. 11, and provides room for the tab 72 to move if the guide 54 is rotated, as described below. The flange 70 prevents insertion of the guide 54 too far into the base 52, and the flange 70 and tab 72 cooperate to hold the guide 54 in place. In this embodiment, both the flange 70 and the tab 72 extend outwardly past the periphery of the base passage 58, which assists in preventing the guide 54 from moving vertically within the base 52.

As shown in FIGS. 4-9, the guide 54 also has a passage 74 therethrough, which is cooperatively dimensioned with the outer surface of the extension bolt 36 to create a locking arrangement between the guide 54 and the bolt 36, such that the extension bolt 36 is rotationally fixed with respect to the guide 54, as described below. In the embodiment shown in FIGS. 4-9, the passage 74 is a hex-shaped passage having six inner walls 76. In one embodiment, the guide 54 is made from plastic or another resilient material or combination of materials, making the tab 72 and the inner and outer surfaces 68, 76 more flexible and resilient. If the guide 54 is manufactured from plastic, injection molding or other plastic molding techniques may be used for manufacturing. The guide 54 may alternately be made from another suitable material or combination of materials.

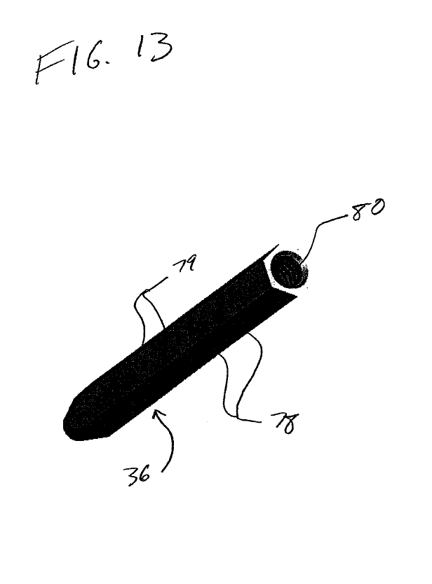

The extension bolt 36 is adapted to be received in the guide 54 when the guide assembly 50 is assembled. The extension bolt 36 has a hex-shaped outer surface with six outer walls 78 and six points 79, and is cooperatively dimensioned to engage the inner walls 76 of the passage 74 so that the fit between the bolt 36 and the guide 54 is sufficiently tight to hold the bolt 36 in position, making the bolt 36 rotationally fixed with respect to the guide 54. The engagement between the outer surfaces 68 of the guide 54 and the lugs 62 and recesses 63 of the base 52 are also sufficiently tight to prevent unwanted rotation of the bolt 36, but sufficiently loose that the guide 54 can be rotated within the passage 58 by application of sufficient torque, such as by using a wrench on the bolt 36, shown by arrows A in FIG. 6. Manufacturing the guide 54 from a resilient material can facilitate rotation of the bolt 36 within the guide assembly 50. The base 52 may additionally or alternately be manufactured from a resilient material, or may have a resilient material lining the passage 58 to facilitate rotating the guide 54 within the passage 58. As shown in FIGS. 6 and 13, the extension bolt 36 has a threaded cavity 80 at one end for connection to the rod 40 of the extension bolt assembly 32. The extension bolt 36 and the rod 40 can be connected and disconnected from the lock mechanism 28 by rotating the extension bolt 36 to loosen the connection between the rod 40 and the actuator 34. The threaded connection 37 between the bolt 36 and the rod 40 may be provided with a locking compound, adhesive, cement, or other means for securing the connection, so that the rod 40 does not separate from the bolt 36 while turning the bolt 36 to disconnect the rod 40 from the actuator 34. The bolt 36 may also contain ball bearings (not shown) to adjust the height of the bolt 36, as known in the art.

Mounting the multi-point locking assembly 10 in the door 14 may be done with the door 14 separated from the frame 18. The lock mechanism 28 is first inserted and mounted in the door 14, and the guide assembly 50 is assembled and mounted in the top and/or bottom surfaces 23, 25 of the door 14. The extension bolt 36 and the rod 40 are also connected together and then inserted through the passage 74 in the guide 54 to bring the rod 40 in position for connection to the actuator 34. The extension bolt 36 may be tightly connected to the rod 40 before insertion into the door 14, such as by threading the rod 40 and the bolt 36 together until the threaded connection 37 is tight, so that rotation of the bolt 36 will also cause rotation of the rod 40. The rod 40 may not be tightly connected to the actuator 34, so that the threaded connection 39 can be adjusted or disconnected by rotation of the extension bolt 36, as described below. Generally, the actuator 34 will be in the extended (locked) position for connection to the extension bolt assembly 32, allowing the tip of the extension bolt 36 to protrude from the door 14 to allow gripping thereof. The bolt assembly 32 is then rotated, such as by gripping the bolt 36 with a wrench, to thread the rod 40 into connection with the actuator 34. In another embodiment, the extension bolt 36 may be directly connected to the actuator 34, without a rod 40 or other interconnecting member.

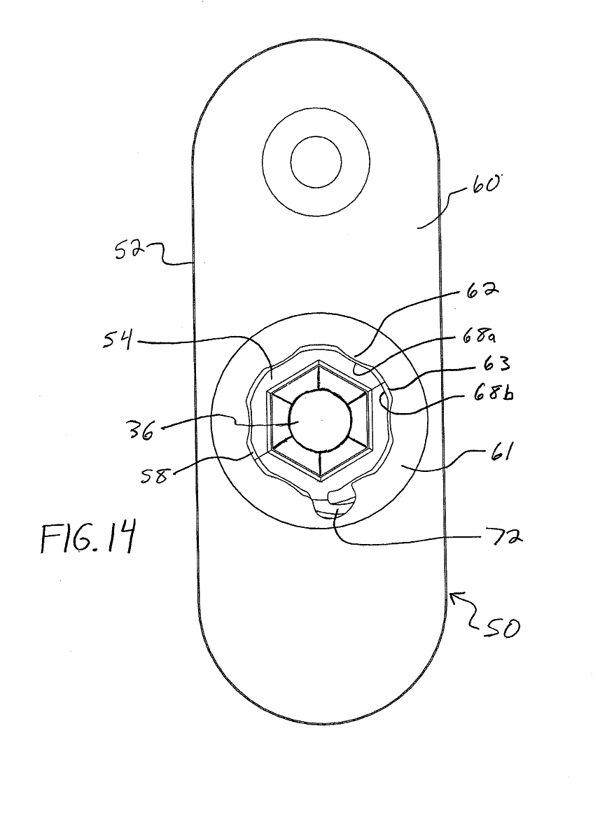

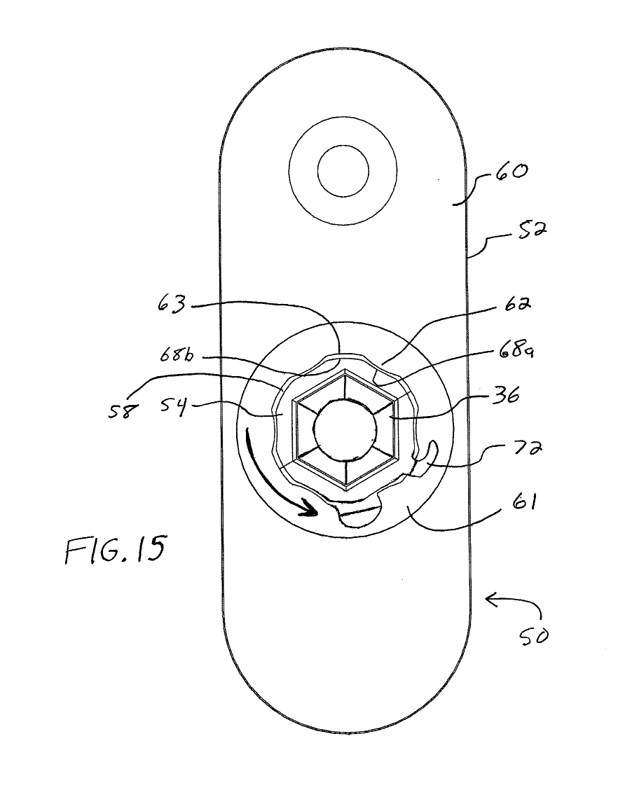

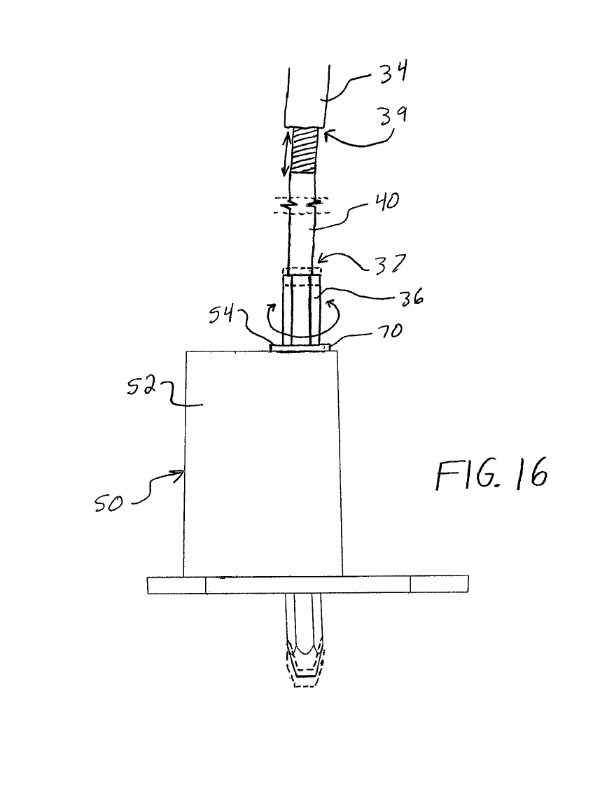

As described above, the bolt 36 can be rotated within the guide assembly 50 by application of sufficient torque, so that the guide 54 is able to slip and rotate within the cavity 58 of the base member, as illustrated in FIGS. 14-15. In this embodiment, the bolt assembly 32 is rotated, such as by gripping the bolt 36 with a wrench, to thread the rod 40 into connection with the actuator 34. Engagement between the protrusions 68b of the guide 54 and the lugs 62 of the base 52 operates to resist rotation of the guide 54 within the base 52 until a sufficient amount of torque is applied to cause the protrusions 68b to slip past the lugs 62, at which point the guide 54 will rotate. In this embodiment, the guide 54 rotates until the protrusions 68b are once more received in the recesses 63 of the base 52 and the lugs 62 are received in the recesses 68a of the base 54, as illustrated in FIG. 15. This configuration allows for incremental rotation of the guide 54 within the base 52, as illustrated in FIGS. 14-15. In a hexagonal configuration such as the one shown in FIGS. 14-15, each incremental rotation equals approximately 60°. FIG. 15 illustrates the guide 54 being incrementally rotated 60° from the position as shown in FIG. 14. It is understood that in other embodiments, where the guide 54 and the base 52 may have different configurations, this incremental rotation may be greater or smaller in angular degree. FIG. 16 also illustrates that the countersunk region 16 provides room for the tab 72 of the guide 54 to move during rotation of the guide 54 within the passage 58. As described above, the tab 72 and the flange 70 lock the guide 54 within the passage 58 once inserted.

Additionally, the guide may be configured to create an audible indication and/or a tactile indication for each incremental rotation. In this embodiment, an audible click is emitted and/or a tactile feel, (such as a “snap”) is detectable when the protrusions 68b of the guide 54 pass the lugs 62 of the base 52 and snap into the recesses 63 in the base, so that the recesses 68a of the guide 54 are adjacent the lugs 62 of the base. This click and tactile feel indicate that the incremental rotation has occurred, and makes the incremental rotation easily detectable, which can be useful in adjusting the extension bolt 36, as described below. Further, the passage 58 and the guide 54 are designed so that after each incremental rotation, one of the flat surfaces 78 of the bolt 36 will be parallel to the lock face 24 of the door 14, because the concave surfaces 68a of the guide 54 are positioned in alignment with the flat inner surfaces 76 of the guide 54. This configuration reduces the wear on the receiver 26, as it ensures that the flat surfaces of the receiver 26 are contacted by the flat surfaces 78 of the bolt 36, rather than the points 79. It is understood that the extension bolt assembly 32 may be connected to the actuator 34 prior to or after mounting the guide assembly 50 in the door.

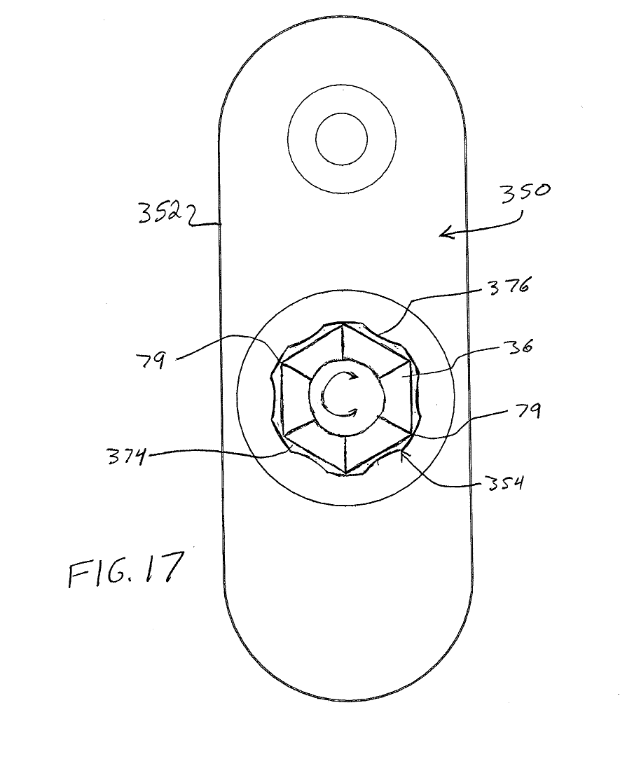

In another embodiment, shown in FIG. 17, the guide assembly 350 may be designed so that the bolt 36 rotates within the guide 354, rather than the guide 54 rotating within the base 52. In such an embodiment, the guide 354 has a plurality of protrusions within the passage 374 that receives the bolt 36, and it is not necessary for the guide 354 to be a piece separate from the base 352. This rotation can be used to accomplish the same function described above, in allowing the bolt 36 to be rotated within the guide assembly 350. In this embodiment, when rotating the bolt 36 within the guide assembly 350, the engagement of the points 79 and the protrusions 376 of the passage 374 causes an audible click to be emitted and a tactile feel to be detectable when the points 79 of the bolt 36 slip past the protrusions 376 of the passage 374. In this position, one of the flat surfaces 378 of the bolt 36 will also be parallel to the lock face 24 of the door 14, due to the positioning of the guide 354. It is understood that the bolt 36, the guide 354, and/or the base 352 may be modified for this configuration.

The extension bolt assembly 32 can be adjusted by rotating the bolt 36 as described above. As shown in FIG. 16, rotation of the bolt 36 causes the bolt 36 and the rod 40 to rotate, and causes the threaded connection 39 to advance or retract. The advancement and retraction of the threaded connection 39, in turn, causes the extension bolt 36 to be vertically displaced and to extend a smaller or greater distance outside of the guide assembly 50 in the extended position, as illustrated by the arrows in FIG. 16. It is understood that when the guide assembly 50 is mounted in a door 16 as shown in FIG. 1, this adjustment changes the distance that the bolt 36 extends outside the respective surface 23, 25 of the door 16. The incremental rotation of the bolt 36 described above allows for small, controlled adjustments of the bolt 36. In other words, each incremental rotation (e.g. 60° rotation in FIGS. 14-15) of the bolt 36 causes a small extension or retraction of the tip of the bolt 36, and each successive incremental rotation causes a substantially equal additional increment of extension or retraction. The audible click and/or tactile feel assist in alerting a user to the incremental rotation and extension/retraction. In addition, the guide 54 resists rotation under small amounts of torque, which prevents the bolt 36 from slipping and inadvertently rotating, which may necessitate future adjustment. In some embodiments, this adjustment can be performed without removing the door 16 from the frame 18. It is understood that where the extension bolt 36 is not tightly connected to the rod 40, or where the extension bolt 36 is directly connected to the actuator 34 and no interconnecting rod 40 is used, the rotation of the bolt 36 can gradually advance or retract the threaded connection 37 to the extension bolt 36 with a similar effect.

Additionally, because the bolt 36 can be rotated within the guide assembly 50, the bolt 36 can be disconnected from the lock mechanism 28 without removing the guide assembly 50. This allows the bolt assembly 32 and/or the lock mechanism 28 to be easily removed from the door 14, such as if one or both components needs to be repaired or replaced. To do this, the door 14 is first removed from the frame 18, and the lock mechanism 28 is actuated to extend the bolt 36. In an embodiment as illustrated in FIG. 1, where the rod 40 is tightly connected to the bolt 36, rotation of the bolt 36 within the guide assembly 50 causes the rod 40 to also rotate until the rod 40 is disconnected from the lock mechanism 28 by unthreading of the threaded connection 39. In other embodiments, where the extension bolt 36 is not tightly connected to the rod 40, or where the extension bolt 36 is directly connected to the actuator 34 and no interconnecting rod 40 is used, the rotation of the bolt 36 causes the bolt 36 to be come disconnected. The lock mechanism 28 and/or the extension bolt assembly 32 can then be removed from the door 14. Re-mounting of the multi-point locking assembly 10 can be performed as described above.

In existing multi-point locking assemblies, the guide assembly must be removed from the door 14 in order to adjust the extension bolt and/or remove the bolt and the lock mechanism from the door, because the bolt cannot be rotated within the guide assembly. Accordingly the weather stripping 21 must either contain a gap the size of the mounting plate of the guide assembly to allow room for removing the guide assembly, or the weather stripping 21 must be removed prior to removing the guide assembly. With the locking assembly 10 described above, the weather stripping 21 needs only to have a gap as wide as the extension bolt 36, since the extension bolt 36 can be disconnected from the lock mechanism 28 without removing the guide assembly 50. The weather stripping 21 and the gap 21A therein are illustrated by broken lines in FIG. 11. In one embodiment, the extension bolt has a width of 5/16″, and the weather stripping 21 is only required to have a gap of that size. Water leakage and other problems can thereby be reduced. The locking assembly 10 provides additional benefits and advantages that are recognized by those skilled in the art.

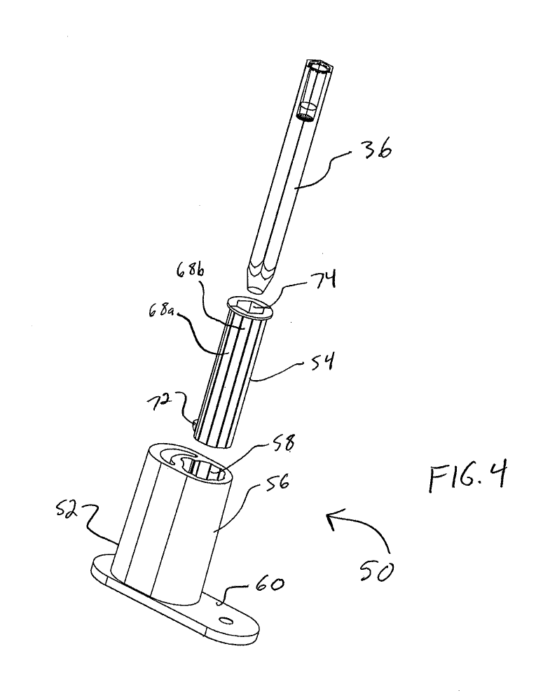

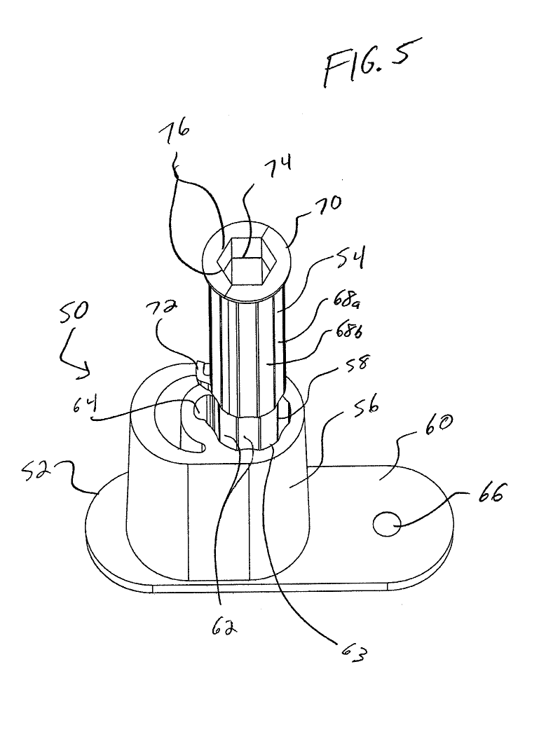

FIGS. 2 and 3 each illustrate prior art multi-point locking assemblies 110, 210, each having extension bolt assemblies 132, 232 with different configurations, using similar types of locking mechanisms 130, 230, which may be modified for use with the present invention. The components of the door assembly 12 are substantially the same as described above with respect to the locking assembly 10 of FIG. 1, and thus, are referred to using the same reference numerals and will not be described again. In the prior art configuration shown in FIG. 2, both the actuator 134 and the extension bolt assembly 132 extend adjacent the lock face 24 of the door 14. In the prior art configuration shown in FIG. 3, the actuator 234 extends adjacent the lock face 24 of the door, similarly to FIG. 2, and the extension bolt assembly 232 is offset from the actuator 234 and extends within a channel 33 in the door. In the illustrated configuration, the actuator 234 is provided with an adaptor 231 to offset the axis of the rod 240 and the extension bolt 236 from the axis of the actuator 234. As stated above, these locking assemblies 110, 210 can be modified to use the extension bolt assembly 32 shown and described herein. For example, the actuators 134, 234 may be modified to connect to the extension bolt assembly 32, such as by including threading on the actuator 134, 234.

A door assembly 12 as shown in FIG. 1, having a primary door 14 and a secondary door 16, the secondary door 16 may also contain a lock assembly. This lock assembly may be an active lock assembly, such as the lock assembly 10 shown in FIG. 1, or a passive lock assembly that works in conjunction with an active lock assembly. The extension bolt assembly 32 described herein can be used in conjunction with a passive lock assembly or an active lock assembly, or a lock assembly that does not involve additional locking structure, such as a locking member 42 or deadbolt member 48.

The lock mechanism 28, the extension bolt assembly 32, and the guide assembly 50 described above provide benefits and advantages over existing assemblies, many of which are described above. For example, the guide assembly 50 allows rotation of the extension bolt 36 and the connecting rod 40 without removing the guide assembly 50 and/or the weather stripping 21 from the door 16. This permits the extension bolt 36 and the rod 40 to be adjusted easily without removal of the guide assembly 50 and/or the weather stripping 21. This also permits the extension bolt 36 and the rod 40 to be disconnected and removed, and the lock mechanism 28 to be removed from the door 16, without removal of the guide assembly 50 and/or the weather stripping 21. Further, the incremental rotation of the bolt 36 assists in adjusting the bolt 36 in a controlled, incremental manner, and the audible click and/or tactile feel assist a person in detecting the adjustment. Still further benefits and advantages are recognizable to those skilled in the art upon reading this disclosure.

Several alternative embodiments and examples have been described and illustrated herein. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the invention may be embodied in other specific forms without departing from the spirit or central characteristics thereof. The present examples and embodiments, therefore, are to be considered in all respects as illustrative and not restrictive, and the invention is not to be limited to the details given herein. The terms “first,” “second,” “top,” “bottom,” etc., as used herein, are intended for illustrative purposes only and do not limit the embodiments in any way. Additionally, the term “plurality,” as used herein, indicates any number greater than one, either disjunctively or conjunctively, as necessary, up to an infinite number. Accordingly, while the specific embodiments have been illustrated and described, numerous modifications come to mind without significantly departing from the spirit of the invention and the scope of protection is only limited by the scope of the accompanying claims.

What is claimed is:

1. A locking assembly for use with a door mounted within a frame, the multi-point locking assembly comprising:
a lock mechanism adapted to be mounted in the door, the lock mechanism having a moveable actuator;
an extension bolt assembly removably connected to the actuator, the extension bolt assembly comprising an extension bolt, wherein the extension bolt is moveable by movement of the actuator between an extended position and a retracted position, wherein the extension bolt is adapted to engage the frame in the extended position to lock the door to the frame; and
a guide assembly adapted to be mounted in the door adjacent the frame, the guide assembly having a passage therethrough, wherein the extension bolt extends through the passage in the guide assembly and the extension bolt is rotatable within the passage.

2. The locking assembly of claim 1, wherein the guide assembly comprises:
a base adapted to be mounted in the door; and
a guide received within the base, the guide having the passage therethrough for receiving the extension bolt.

3. The locking assembly of claim 2, wherein the bolt is rotationally fixed with respect to the guide, and the guide is rotatable within a base passage in the base to effect rotation of the bolt with respect to the guide assembly.

4. The locking assembly of claim 3, wherein the base passage comprises a plurality of lugs with recesses located between the lugs and an outer surface of the guide comprises a plurality of protrusions with flutes located between the protrusions.

5. The locking assembly of claim 4, wherein the guide and the base passage are cooperatively dimensioned so that when torque is applied to the bolt, the lugs of the base passage contact the protrusions of the guide to resist rotation of the guide within the base passage, and wherein application of sufficient torque causes the lugs to slip past the protrusions to permit rotation of the guide and the bolt within the passage.

6. The locking assembly of claim 5, wherein the guide is configured to create at least one of an audible indication and a tactile indication when the lugs slip past the protrusions.

7. The locking assembly of claim 4, wherein when no torque is applied to the bolt, the lugs of the base passage are received in the flutes of the guide, and the protrusions of the guide are received in the recesses of the base passage.

8. The locking assembly of claim 1, wherein the extension bolt assembly comprises a threaded connection, and wherein rotation of the extension bolt results in a change in vertical height of the extension bolt through action of the threaded connection.

9. The locking assembly of claim 8, wherein the extension bolt assembly further comprises a connecting rod connected at one end to the actuator by the threaded connection and connected at an opposite end to the extension bolt, and wherein rotation of the extension bolt results in rotation of the rod and a change in vertical height of the rod through action of the threaded connection.

10. The locking assembly of claim 1, wherein the guide assembly further comprises a base and a guide formed of a single piece, the guide having the passage therethrough for receiving the bolt, and wherein the bolt is rotatable within the passage in the guide.

11. A guide assembly for use with a locking assembly for a door mounted within a frame, the locking assembly having a moveable extension bolt operably connected thereto, the guide assembly comprising:
a base adapted to be mounted in the door, the base having a base passage therethrough; and
a guide received within the base passage, the guide having a passage adapted to receive the extension bolt therethrough, wherein the guide is rotatable with respect to the base and is adapted to be rotationally fixed with respect to the extension bolt to permit rotation of the extension bolt with respect to the guide assembly by rotation of the guide within the base passage.

12. The guide assembly of claim 11, wherein the base passage comprises a plurality of lugs with recesses located between the lugs and an outer surface of the guide comprises a plurality of protrusions with flutes located between the protrusions.

13. The guide assembly of claim 12, wherein the guide and the bases passage are cooperatively dimensioned so that when torque is applied to the bolt, the lugs of the base passage contact the protrusions of the guide to resist rotation of the guide within the base passage, and wherein application of sufficient torque causes the lugs to slip past the protrusions to permit rotation of the guide within the passage.

14. The guide assembly of claim 13, wherein the guide is configured to create at least one of an audible indication and a tactile indication when the lugs slip past the protrusions.

15. The guide assembly of claim 12, wherein when no torque is applied to the bolt, the lugs of the base passage are received in the flutes of the guide, and the protrusions of the guide are received in the recesses of the base passage.

16. The guide assembly of claim 11, wherein the guide comprises a flange located at a first end and a tab located at a second opposite end, and wherein the flange and the tab retain the guide within the base.

17. The guide assembly of claim 16, wherein the base comprises a countersunk region surrounding the base passage, wherein the tab is positioned within the countersunk region and travels through the countersunk region when the guide rotates within the base.

18. The guide assembly of claim 16, wherein the base passage has a notch, and wherein when the guide assembly is inserted into the base passage, the tab is received within the notch and flexes toward the guide to permit insertion of the guide into the base passage.

19. A locking assembly for use with a door mounted within a frame, the multi-point locking assembly comprising:
a lock mechanism adapted to be mounted in the door, the lock mechanism comprising a handle and an actuator that is moveable by manipulation of the handle;
an extension bolt assembly comprising a connecting rod threadably connected to the actuator and an extension bolt connected to the connecting rod, wherein the extension bolt is moveable by manipulation of the handle and movement of the actuator between an extended position and a retracted position, wherein the extension bolt is adapted to engage the frame in the extended position to lock the door to the frame; and
a guide assembly adapted to be mounted in the door adjacent the frame, the guide assembly comprising:
a base adapted to be mounted in the a cavity in the door, the base having a base passage therethrough, wherein the base passage includes a plurality of lugs with recesses located between the lugs; and
a tubular guide received within the base passage, the guide having a passage adapted to receive the extension bolt therethrough, wherein the guide is rotatable with respect to the base and is adapted to be rotationally fixed with respect to the extension bolt to permit rotation of the extension bolt with respect to the guide assembly by rotation of the guide within the base passage, wherein an outer surface of the guide comprises a plurality of protrusions with flutes located between the protrusions,
wherein the guide and the base passage are cooperatively dimensioned so that when torque is applied to the bolt, the lugs of the base passage contact the protrusions of the guide to resist rotation of the guide within the base passage, and wherein application of sufficient torque causes the lugs to slip past the protrusions to permit rotation of the guide and the bolt within the passage.

20. The locking assembly of claim 19, wherein the connecting rod is connected at one end to the actuator by a threaded connection and connected at an opposite end to the extension bolt, and wherein rotation of the extension bolt results in rotation of the rod and a change in vertical height of the rod through action of the threaded connection.
